(19) United States
(12) Patent Application Publication
(10) Pub. No.: US 2020/0028884 A1
(43) Pub. Date: Jan. 23, 2020

(54) ENHANCED TELECONFERENCING USING NOISE FILTERING, AMPLIFICATION, AND SELECTIVE MUTING

(71) Applicant: International Business Machines Corporation, Armonk, NY (US)

(72) Inventors: Adam B. Childers, Tucson, AZ (US); Lynda L. Anderson, Saugerties, NY (US); Ranjana Godse, Fishkill, NY (US); Richard B. Finch, New Paltz, NY (US); Roberto Aceves Verdin, Zapopan (MX); Daniel N. Mikhail, Poughkeepsie, NY (US); Karen Jasso Perea, Jalisco (MX)

(21) Appl. No.: 16/039,708

(22) Filed: Jul. 19, 2018

Related U.S. Application Data
(63) Continuation of application No. 16/038,456, filed on Jul. 18, 2018.

(51) Int. Cl. H04L 29/06; G06K 9/00; G10L 21/0208; H04N 7/15; G10L 21/0316

(52) U.S. Cl. CPC H04L 65/1083; G06K 9/00228; G10L 21/0208; G10L 21/0316; H04N 7/15

(57) ABSTRACT

Examples of techniques for enhanced teleconferencing are disclosed. In one example implementation according to aspects of the present disclosure, a computer-implemented method includes monitoring, by a processing device, a teleconference having a plurality of participants, a plurality of participant devices being used to facilitate the teleconference, each of the plurality of participants being associated with one of the plurality of participant devices. The method further includes detecting, by the processing device, a low volume of a channel associated with one of the plurality of participant devices. The method further includes, responsive to detecting the low volume associated with the one of the plurality of participants, amplifying, by the processing device, the channel to increase volume without amplifying other channels associated with other of the plurality of participant devices.

### CROSS-REFERENCE TO RELATED APPLICATIONS

This application is a continuation of U.S. patent application Ser. No. 16/038,456, entitled “ENHANCED TELECONFERENCING USING NOISE FILTERING, AMPLIFICATION, AND SELECTIVE MUTING,” filed Jul. 18, 2018, the disclosure of which is incorporated by reference herein in its entirety.

### BACKGROUND

The present invention generally relates to processing systems, and more specifically, to enhanced teleconferencing using noise filtering, amplification, and selective muting.

Teleconferencing enables multiple participants to connect together to exchange ideas and information when the participants are not necessarily in the same geographic location. Teleconferencing can be implemented using many different technological platforms, service providers, etc. and can enable audio and/or video sharing among the participants. Generally, each participant (or a group of participants) uses a participant device (e.g., a smartphone, a telephone, a computer, etc.) to connect to a teleconferencing platform that facilitates the teleconference.

### SUMMARY

Embodiments of the present invention are directed a computer-implemented method for enhanced teleconferencing. A non-limiting example of the computer-implemented method includes monitoring, by a processing device, a teleconference having a plurality of participants, a plurality of participant devices being used to facilitate the teleconference, each of the plurality of participants being associated with one of the plurality of participant devices. The method further includes detecting, by the processing device, a trigger event associated with one of the plurality of participants. The method further includes, responsive to detecting the trigger event associated with the one of the plurality of participants, disabling a mute setting for one of the plurality of participant devices that is associated with the one of the plurality of participants. Other embodiments are directed to systems and computer program products for implementing the method for enhanced teleconferencing.

Embodiments of the present invention are directed a computer-implemented method for enhanced teleconferencing. A non-limiting example of the computer-implemented method includes monitoring, by a processing device, a teleconference having a plurality of participants, a plurality of participant devices being used to facilitate the teleconference, each of the plurality of participants being associated with one of the plurality of participant devices. The method further includes detecting, by the processing device, a low volume of a channel associated with one of the plurality of participant devices. The method further includes, responsive to detecting the low volume associated with the one of the plurality of participants, amplifying, by the processing device, the channel to increase volume without amplifying other channels associated with other of the plurality of participant devices. Other embodiments are directed to systems and computer program products for implementing the method for enhanced teleconferencing.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments described herein;

FIG. 2 depicts abstraction model layers according to one or more embodiments described herein;

FIG. 3 depicts a block diagram of a processing system for implementing the described techniques according to one or more embodiments described herein;

FIG. 4 depicts a block diagram of a teleconferencing environment for using a teleconferencing system according to one or more embodiments described herein;

FIG. 5 depicts a block diagram of a teleconferencing system according to one or more embodiments described herein;

FIG. 6 depicts a flow diagram of a method 600 for selective muting according to one or more embodiments described herein; and

FIG. 7 depicts a flow diagram of a method 700 for noise filtering and amplification according to one or more embodiments described herein.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that, although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

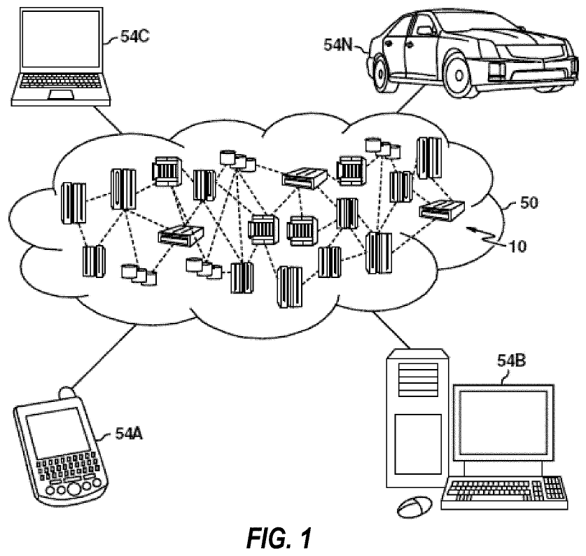

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

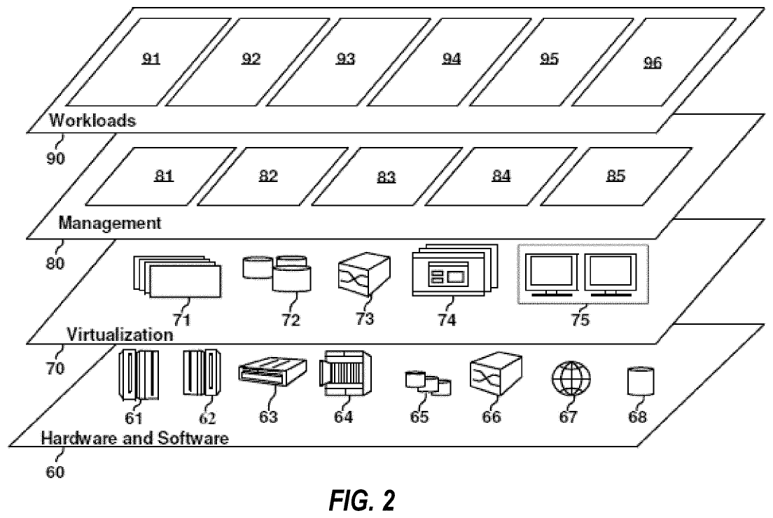

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and enhanced teleconferencing 96.

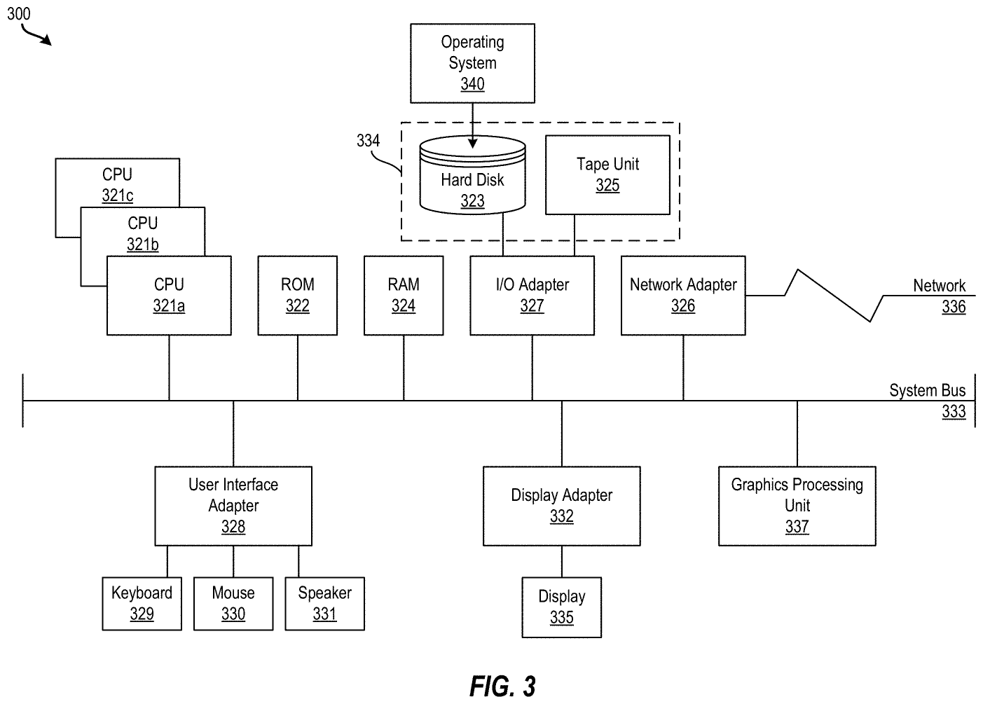

It is understood that the present disclosure is capable of being implemented in conjunction with any other type of computing environment now known or later developed. For example, FIG. 3 depicts a block diagram of a processing system 300 for implementing the techniques described herein. In examples, processing system 300 has one or more central processing units (processors) 321a, 321b, 321c, etc. (collectively or generically referred to as processor(s) 321 and/or as processing device(s)). In aspects of the present disclosure, each processor 321 can include a reduced instruction set computer (RISC) microprocessor. Processors 321 are coupled to system memory (e.g., random access memory (RAM) 324) and various other components via a system bus 333. Read only memory (ROM) 322 is coupled to system bus 333 and may include a basic input/output system (BIOS), which controls certain basic functions of processing system 300.

Further depicted are an input/output (I/O) adapter 327 and a network adapter 326 coupled to system bus 333. I/O adapter 327 may be a small computer system interface (SCSI) adapter that communicates with a hard disk 323 and/or a tape storage drive 325 or any other similar component. I/O adapter 327, hard disk 323, and tape storage device 325 are collectively referred to herein as mass storage 334. Operating system 340 for execution on processing system 300 may be stored in mass storage 334. The network adapter 326 interconnects system bus 333 with an outside network 336 enabling processing system 300 to communicate with other such systems.

A display (e.g., a display monitor) 335 is connected to system bus 333 by display adaptor 332, which may include a graphics adapter to improve the performance of graphics intensive applications and a video controller. In one aspect of the present disclosure, adapters 326, 327, and/or 232 may be connected to one or more I/O busses that are connected to system bus 333 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 333 via user interface adapter 328 and display adapter 332. A keyboard 329, mouse 330, and speaker 331 may be interconnected to system bus 333 via user interface adapter 328, which may include, for example, a Super I/O chip integrating multiple device adapters into a single integrated circuit.

In some aspects of the present disclosure, processing system 300 includes a graphics processing unit 337. Graphics processing unit 337 is a specialized electronic circuit designed to manipulate and alter memory to accelerate the creation of images in a frame buffer intended for output to a display. In general, graphics processing unit 337 is very efficient at manipulating computer graphics and image processing, and has a highly parallel structure that makes it more effective than general-purpose CPUs for algorithms where processing of large blocks of data is done in parallel.

Thus, as configured herein, processing system 300 includes processing capability in the form of processors 321, storage capability including system memory (e.g., RAM 324), and mass storage 334, input means such as keyboard 329 and mouse 330, and output capability including speaker 331 and display 335. In some aspects of the present disclosure, a portion of system memory (e.g., RAM 324) and mass storage 334 collectively store an operating system such as the AIX® operating system from IBM Corporation to coordinate the functions of the various components shown in processing system 300.

Turning now to an overview of technologies that are more specifically relevant to aspects of the invention, as more professionals and other workers work remotely from one another, teleconferencing frequency has increased. Although teleconferencing is convenient for remote participants, there can be a variety of distractions that disrupt the efficiency of a call. Oftentimes participants are having side conversations which can be heard by others. Other times, participants are unable to participate while in a quite or private space free from noise and distractions (e.g., a participant participates in a teleconference while in a noisy airport). In such cases, the participant should be on mute and they are not. In other cases, a participant is on mute but forgets to unmute the channel before talking, resulting in other participants missing what the muted participant said. Both cases cause a disruption in the teleconference: either to alert the unmuted participant who is adding disruption/noise or to manually mute/unmute specific users.

Turning now to an overview of the aspects of the invention, one or more embodiments of the invention address the above-described shortcomings of the prior art by providing enhanced teleconferencing using noise filtering, amplification, and selective muting. The technical solutions provided herein represent improvements to teleconferencing and teleconferencing systems. For example, teleconferencing is improved by selective amplification of low or soft signals (e.g., a low channel of a plurality of channels can be amplified to enable that channel to be better heard by other participants). Similarly, teleconferencing is improved by filtering multiple signals from one channel and selectively amplifying one (or more) signals from the one channel (e.g., a low signal of a channel can be amplified to enable that signal to be better heard by other participants). In other words, different signals on the same channel can be prioritized. In other examples, teleconferencing is improved by selectively muting/unmuting channels. For example, a muted channel can be selectively unmuted when the muted channel is spoken into. This can be accomplished using triggers (e.g., using cues such as a participant's name being called by another participant, using visual cues of the participant speaking into a muted channel to unmute the channel automatically or prompt the participant to unmute the channel, etc.).

The above-described aspects of the invention address the shortcomings of the prior art by improving teleconferencing by selectively amplifying a signal on a channel having multiple signals, selectively amplifying a channel among a plurality of channels, and selectively muting/unmuting a channel.

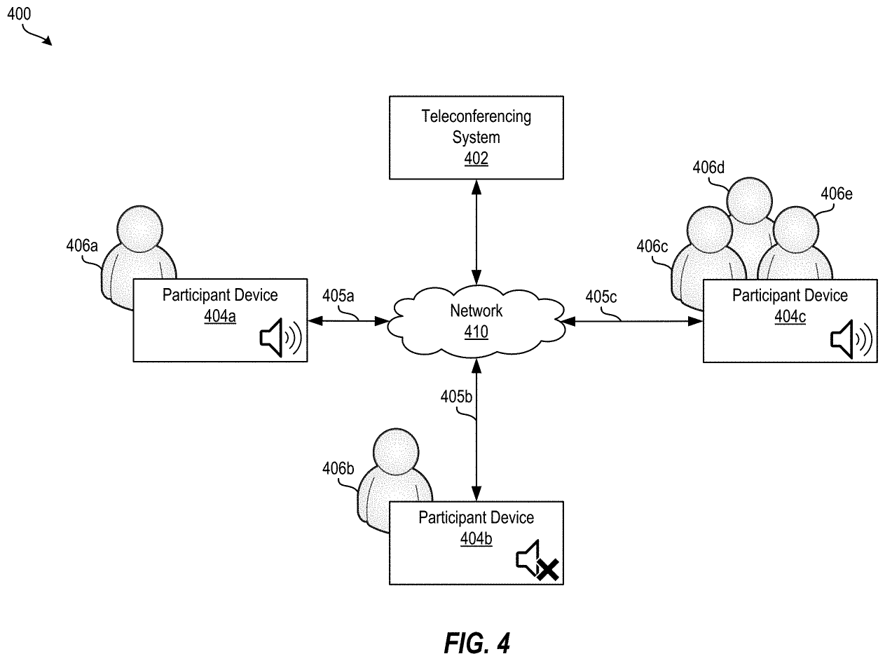

Turning now to a more detailed description of aspects of the present invention, FIG. 4 depicts a block diagram of a teleconferencing environment 400 for using a teleconferencing system 402 according to one or more embodiments described herein. The environment 400 includes the teleconferencing system 402 connected to a plurality of participant devices 404a, 404b, 404c (collectively referred to as “participant devices 404”). The environment 400 can include a network 410, which enables the participant devices to connect to the teleconferencing system 402. The network 410 can be any suitable network, such as an intranet, the Internet, a wide area network, a local area network, etc. and can include various wired and/or wireless devices, such as routers, hubs, switches, and the like.

Each of the participant devices 404 is associated with one or more participants 406a, 406b, 406c, 406d, 406e (collectively referred to as “participants 406”). For example, the participant device 404a is associated with participant 406a; the participant device 404b is associated with participant 406b; the participant device 404c is associated with participants 406c, 406d, 406e. The participants 406 use their associated participant devices 404 to connect to the teleconferencing system 402 to participate in a teleconference. In some embodiments, the teleconferencing system 402 is capable of sharing audio and/or video among the participant devices 404 and may also share other forms of data (e.g., a presentation) among the participant devices 404.

The participant devices 404 create channels 405a, 405b, 405c (collectively referred to as “channels 405”) when connecting to the teleconferencing system 402. For example, participant device 404a creates a channel 405a, participant device 404b creates a channel 405b, and participant device 404c creates a channel 405c. At various times, one or more of the channels 405 can be muted. As shown in FIG. 4, the channel 405b is muted, denoted by the icon associated with the participant device 404b, while the channels 405a and 405c are unmuted. According to one or more embodiments described herein, the teleconferencing system 402 can selectively mute and unmute a channel, for example, to unmute a participant who is talking while the associated participant device is muted. This represents an improvement to teleconferencing system technologies by improving participant engagement, understanding, and the like.

According to one or more embodiments described herein, each of the channels 405 can have a volume level associated therewith such that each of the channels 405 can have a volume different from each other. For example, the channel 405a can have a higher volume than the channel 405b, such as because the participant device 404a has a higher volume setting than the participant device 404b because the participant 406a is speaking louder than the participant 406b, etc. According to one or more embodiments described herein, the teleconferencing system 402 can selectively amplify one or more of the channels, for example, to balance volume among the channels 405. This represents an improvement to teleconferencing system technologies by improving participant engagement, understanding, and the like.

According to one or more embodiments described herein, each of the channels 405 can have multiple signals associated therewith. For example, the channel 405c can have multiple signals. For example, each of the participants 406c, 406d, 406e can speak into separate microphones (not pictured) associated with the participant device 404c. In this case, each microphone creates a separate signal associated with the channel 405c. In another scenario, the participants 406c, 406d, 406e are in the same room and are connected to teleconferencing system 402 via the participant device 404c. If two of these participants (e.g., the participants 406c and 406d) are having a side conversation, the other participants (e.g., the participants 406a and 406b) may be able to hear the side conversation over a participant who is actively talking in the participation of the teleconference (e.g., the participant 406e). According to one or more embodiments described herein, the teleconferencing system 402 can selectively amplify one or more of the signals associated with a channel, for example, to balance volume among the signals and/or the channels 405. This represents an improvement to teleconferencing system technologies by improving participant engagement, understanding, and the like.

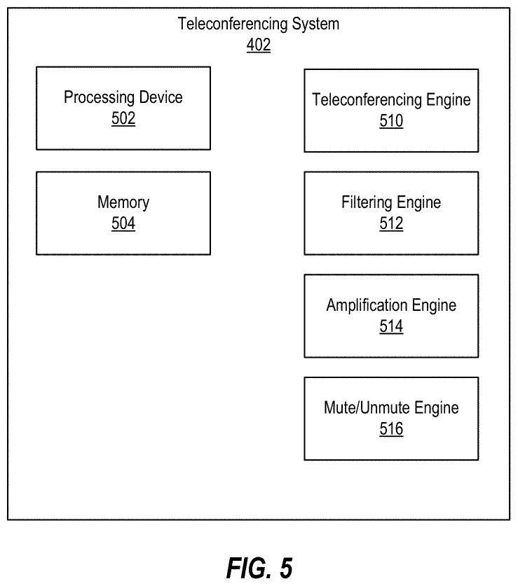

FIG. 5 depicts a block diagram of a teleconferencing system 500 according to one or more embodiments described herein. The teleconferencing system 500 is a processing system that includes a processing device 502, a memory 504, a teleconferencing engine 510, a filtering engine 512, an amplification engine 514, and a mute/unmute engine 516.

The various components, modules, engines, etc. described regarding FIG. 5 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the processing device 502 for executing those instructions. Thus a system memory (e.g., the memory 504) can store program instructions that when executed by the processing device 502 implement the engines described herein. Other engines can also be utilized to include other features and functionality described in other examples herein.

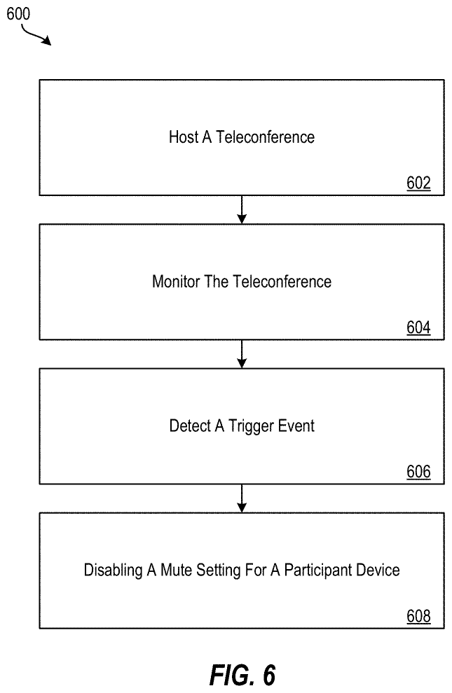

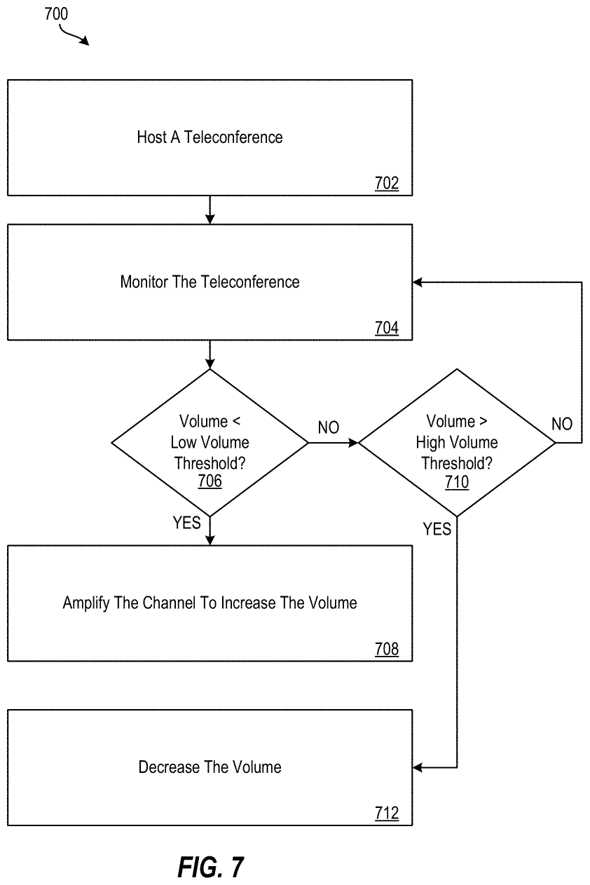

The components, modules, engines, etc. described regarding FIG. 5 are now described in more detail with reference to FIGS. 6 and 7. In particular, FIG. 6 depicts a flow diagram of a method 600 for selective muting according to one or more embodiments described herein. The method 600 can be performed using any suitable processing system or device, such as the processing system 300, teleconferencing system 402, and/or other suitable systems and/or devices.

At block 602, the teleconferencing engine 510 can host a teleconference among a plurality of participants (e.g., the participants 406), which are using participant devices (e.g., the participant devices 404). At block 604, the teleconferencing engine 510 monitors the teleconference among the participants. Each of the participants is associated with one of the plurality of participant devices as depicted in FIG. 4. For example, the teleconferencing engine 510 monitors which participant is speaking, what the volume levels of the various channels are, what the volume levels of signals within channels are, etc.

At block 606, the mute/unmute engine 516 detects a trigger event associated with one of the participants. Examples of trigger events include a participant talking on a participant device that is muted, a participant's name being spoken by another participant, a project with which a participant is associated is mentioned by another participant, etc. According to one or more embodiments described herein, the mute/unmute engine 516 can receive image data from cameras (not shown) associated with the various participant devices 404. The mute/unmute engine 516 can perform image recognition on the data received from a camera to determine whether a participant (in view of the camera) is talking. If so, the mute/unmute engine 516 can determine whether the participant device associated with that user is muted. It should be appreciated that a participant may be seen to be talking but circumstances indicate that the participant device should not be unmuted because the talking is not relevant to the teleconference. For example, if the participant 406b is having a side conversation with another person, the mute/unmute engine 516 may determine, from camera data for example, that the participant is having a side conversation and a trigger event is not detected.

In another example, if the participant device 404b is muted and another participant (e.g., one of the participants 406a, 406c, 406d, 406e) mentions the name of the participant 406b, the name of a project with which the participant 406b is associated, etc., the mute/unmute engine 516 can detect this as a trigger event.

At block 608, responsive to detecting the trigger event, the mute/unmute engine 516 disables a mute setting for one of the plurality of participant devices that is associated with the one of the plurality of participants. For example, when it is determined that a participant is talking, and is supposed to be talking (e.g., based on the occurrence of the trigger event), the participant device can be unmuted by the mute/unmute engine 516. In some examples, the muted participant device (e.g., the participant device 404b) receives an alert that is presented to the participant (e.g., the participant 406b) via an audio and/or visual cue (e.g., a beep produced by a speaker, a message displayed on a display, etc.). The participant device can then be re-muted once the participant is finished talking, after a period of time, when another trigger event occurs (e.g., another participant starts talking, another project is mentioned, another participant is mentioned by name, etc.). According to one or more embodiments described herein, the mute/unmute engine 516 can also mute a participant device when background noise is detected, such as when the participant device is in a noisy environment (e.g., a crowded airport).

Additional processes also may be included, and it should be understood that the process depicted in FIG. 6 represents an illustration and that other processes may be added or existing processes may be removed, modified, or rearranged without departing from the scope and spirit of the present disclosure.

FIG. 7 depicts a flow diagram of a method 700 for noise filtering and amplification according to one or more embodiments described herein. The method 700 can be performed using any suitable processing system or device, such as the processing system 300, teleconferencing system 402, and/or other suitable systems and/or devices.

At block 702, the teleconferencing engine 510 can host a teleconference among a plurality of participants (e.g., the participants 406), which are using participant devices (e.g., the participant devices 404). At block 604, the teleconferencing engine 510 monitors the teleconference among the participants. Each of the participants is associated with one of the plurality of participant devices as depicted in FIG. 4. For example, the teleconferencing engine 510 monitors which participant is speaking, what the volume levels of the various channels are, what the volume levels of signals within channels are, etc.

At decision block 706, it is determined whether the volume is low, such as by comparing the volume to a low volume threshold. For example, the amplification engine 514 detects a low volume of a channel associated with one of the plurality of participant devices. If it is determined at decision block 706 that the volume is less than the low volume threshold (i.e., the volume is too low compared to the low volume threshold), the amplification engine 514 amplifies the channel at block 708 to increase the volume of that channel without amplifying other channels.

If it is determined at decision block 706 that the volume is not less than the low volume threshold, it is determined at decision block 710 whether the volume is greater than a high volume threshold. For example, the amplification engine 514 detects a high volume of a channel associated with one of the plurality of participant devices. If it is determined at decision block 710 that the volume is greater than the high volume threshold (i.e., the volume is too high compared to the high volume threshold), the amplification engine 514 decreases the volume of the channel without decreasing other channels at block 712. The low volume threshold and/or the high volume threshold can be set manually, such as based on user preference, or automatically, such as based on average volumes of the teleconference, an expected average volume based on other teleconferences, a highest volume, a lowest volume, or other factors.

According to one or more embodiments described herein, a channel can include multiple signals as described herein. In such cases, detecting a low volume of a channel can include detecting a low volume of one of a plurality of signals of the channel. In such cases, the amplifying the channel to increase volume further includes the amplification engine 514 amplifying the signal of the one of the plurality of signals of the channel without amplifying other signals of the plurality of signals. Signals can also be reduced to lower volume when it is determined that the volume is too high.

Additional processes also may be included. For example, the method 700 can include the filtering engine 512 filtering background noise from a channel or signal. In this way, background noise can be filtered. For example, if two participants (e.g., the participants 406c and 406d are having a side conversation, a signal or channel carrying noise from the side conversation can be reduced compared to other signals or channels, which may be in use for facilitating the teleconference (i.e., signals or channels that are being used by participants engaged in discussion during the teleconference). The filtering may also be used to filter out background noise from a channel by reducing a level of a signal on the channel that carries the background noise.

It should be understood that the process depicted in FIG. 7 represents an illustration, and that other processes may be added or existing processes may be removed, modified, or rearranged without departing from the scope and spirit of the present disclosure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for enhanced teleconferencing, the method comprising:
monitoring, by a processing device, a teleconference having a plurality of participants, a plurality of participant devices being used to facilitate the teleconference, each of the plurality of participants being associated with one of the plurality of participant devices;
detecting, by the processing device, a low volume of a communication channel associated with one of the plurality of participant devices; and
responsive to detecting the low volume associated with the one of the plurality of participants, amplifying, by the processing device, the communication channel to increase volume without amplifying other communication channels associated with other of the plurality of participant devices.

2. The computer-implemented method of claim 1, further comprising detecting a high volume of a communication channel associated with one of the plurality of participant devices.

3. The computer-implemented method of claim 2, further comprising, responsive to detecting the high volume associated with the one of the plurality of participants, reducing, by the processing device, amplification for the communication channel to decrease the volume without decreasing the volume of other communication channels associated with other of the plurality of participant devices.

4. The computer-implemented method of claim 1, wherein the communication channel comprises a plurality of signals.

5. The computer-implemented method of claim 4, wherein detecting a low volume of a communication channel associated with one of the plurality of participant devices comprises detecting a low volume of one of the plurality of signals of the communication channel.

6. The computer-implemented method of claim 5, wherein amplifying the communication channel to increase volume further comprises amplifying the signal of the one of the plurality of signals of the communication channel without amplifying other signals of the plurality of signals.

7. The computer-implemented method of claim 1, further comprising reducing the volume of a communication channel when it is determined that the communication channel contains background noise.

8. The computer-implemented method of claim 1 further comprising, prior to monitoring the teleconference, hosting, by the processing device, the teleconference for the plurality of participants.

9. A system comprising:
a memory comprising computer readable instructions; and
a processing device for executing the computer readable instructions for performing a method for enhanced teleconferencing, the method comprising:
monitoring, by the processing device, a teleconference having a plurality of participants, a plurality of participant devices being used to facilitate the teleconference, each of the plurality of participants being associated with one of the plurality of participant devices;
detecting, by the processing device, a low volume of a communication channel associated with one of the plurality of participant devices; and
responsive to detecting the low volume associated with the one of the plurality of participants, amplifying, by the processing device, the communication channel to increase volume without amplifying other communication channels associated with other of the plurality of participant devices.

10. The system of claim 9, wherein the method further comprises detecting a high volume of a communication channel associated with one of the plurality of participant devices.

11. The system of claim 10, wherein the method further comprises, responsive to detecting the high volume associated with the one of the plurality of participants, reducing, by the processing device, amplification for the communication channel to decrease the volume without decreasing the volume of other communication channels associated with other of the plurality of participant devices.

12. The system of claim 9, wherein the communication channel comprises a plurality of signals.

13. The system of claim 12, wherein detecting a low volume of a communication channel associated with one of the plurality of participant devices comprises detecting a low volume of one of the plurality of signals of the communication channel.

14. The system of claim 13, wherein amplifying the communication channel to increase volume further comprises amplifying the signal of the one of the plurality of signals of the communication channel without amplifying other signals of the plurality of signals.

15. The system of claim 9, wherein the method further comprises reducing the volume of a communication channel when it is determined that the communication channel contains background noise.

16. The system of claim 9, wherein the method further comprises, prior to monitoring the teleconference, hosting, by the processing device, the teleconference for the plurality of participants.

17. A computer program product comprising:
a computer readable storage medium having program instructions embodied therewith, the program instructions executable by a processing device to cause the processing device to perform a method for enhanced teleconferencing, the method comprising:
monitoring, by the processing device, a teleconference having a plurality of participants, a plurality of participant devices being used to facilitate the teleconference, each of the plurality of participants being associated with one of the plurality of participant devices;
detecting, by the processing device, a low volume of a communication channel associated with one of the plurality of participant devices; and
responsive to detecting the low volume associated with the one of the plurality of participants, amplifying, by the processing device, the communication channel to increase volume without amplifying other communication channels associated with other of the plurality of participant devices.

18. The computer program product of claim 17, wherein the method further comprises detecting a high volume of a communication channel associated with one of the plurality of participant devices.

19. The computer program product of claim 18, wherein the method further comprises, responsive to detecting the high volume associated with the one of the plurality of participants, reducing, by the processing device, amplification for the communication channel to decrease the volume without decreasing the volume of other communication channels associated with other of the plurality of participant devices.

20. The computer program product of claim 17, wherein the communication channel comprises a plurality of signals, wherein detecting a low volume of a communication channel associated with one of the plurality of participant devices comprises detecting a low volume of one of the plurality of signals of the communication channel, and wherein amplifying the communication channel to increase volume further comprises amplifying the signal of the one of the plurality of signals of the communication channel without amplifying other signals of the plurality of signals.
